(19) United States
(12) Patent Application Publication
(10) Pub. No.: US 2008/0022941 A1
(43) Pub. Date: Jan. 31, 2008

(54) Systems and methods for electrically grounding animals

(76) Inventor: Roy J. Mankovitz, Montecito, CA (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/494,417

(22) Filed: Jul. 27, 2006

(51) Int. Cl. A01K 1/03

(52) U.S. Cl. 119/452

(57) ABSTRACT

Systems and methods are effective in electrically grounding animals that are kept indoors, such as pets (dogs, cats, hamsters, iguanas, fish, birds, etc.), lab caged animals used for clinical trials (guinea pigs, rats, etc.). The inventive apparatus and concepts are also applicable to fish and other creatures in aquariums and animals that are kept indoors at night or during harsh weather, including livestock (cattle, sheep, pigs, lamb, etc.) and horse stables.

### FIELD OF THE INVENTION

This invention relates generally to electrical grounding and, in particular, to systems and method for electrically grounding animals, including pets and livestock.

### BACKGROUND OF THE INVENTION

Until relatively recently, human beings walked barefoot and slept directly on the earth, which is electrically neutral. In the last few decades, however, the use of shoes having non-conductive soles, synthetic carpeting and other floor materials have insulated people from the earth. Studies have shown that earth grounding is an important source of free radicals which function as natural antioxidants. It is believed that the prevalence of electrical isolation interferes with normal immune system function and increases inflammation.

With this in mind, U.S. Pat. No. 6,683,779 describes a personal grounding system for collecting and removing unnatural electrical charges from a human body. The system includes a grounding pad having a layer of carbon fibers, and a conductor substantially extending across the layer in conductive contact with the carbon fibers. A ground lead is conductively coupled to the grounding pad conductor at one end thereof and conductively coupled to a grounded anchor at a second end thereof. Preferably, the grounded anchor is placed directly into the earth, although in certain applications constitutes a metal grounding component. The system may include a wall plate in conductive connection with the grounded anchor. The ground lead is removably attached to the wall plate via a connector attached thereto. The grounding pad may be configured to be a sleeping pad, seat pad, or strap or patch attachable to the human body.

### SUMMARY OF THE INVENTION

This invention improves upon the existing art by electrically grounding animals that are kept indoors, such as pets (dogs, cats, hamsters, iguanas, fish, birds, etc.), lab caged animals used for clinical trials (guinea pigs, rats, etc.). The inventive apparatus and concepts are also applicable to fish and other creatures in aquariums and animals that are kept indoors at night or during harsh weather, including livestock (cattle, sheep, pigs, lamb, etc.) and horse stables.

Electrical grounding apparatus includes an electrically conductive element having a first end connected to an electrical ground and a second end connected to a portion of the housing or a member within a housing, such that animal contained in the housing is intentionally electrically grounded upon contact with the portion of the housing or member within the housing.

The housing may be an electrically conductive cage or an aquarium, and the member within the housing may be an electrically conductive perch, an electrically conductive food or water bowl, an electrically conductive sleeping pad, or an electrically conductive food or water bowl.

### BRIEF DESCRIPTION OF THE DRAWINGS

FIG. 1 is a drawing that shows the invention applied to a small animal cage;

FIG. 2 is a drawing that shows the invention applied to a bird cage; and

FIG. 3 is a drawing that shows the invention applied to an aquarium.

### DETAILED DESCRIPTION OF THE INVENTION

All animals naturally spend their lives in electrical contact with the earth; mammals through their foot pads on the soil, fish through the conductive mineral water of the sea and lakes, and birds through the conductivity of tree bark. This conductive path provides a means to discharge any electrical field charge that might build up in the body of the animal, and there may be some reverse flow of electrons from the earth to the body.

This invention inhibits the build up of electrical charge and potential ill effects by electrically grounding animals that are kept indoors; lab-caged animals used for clinical trials, fish and other aquarium creatures, and animals that are kept indoors at night or during harsh weather, including livestock, horses, etc.

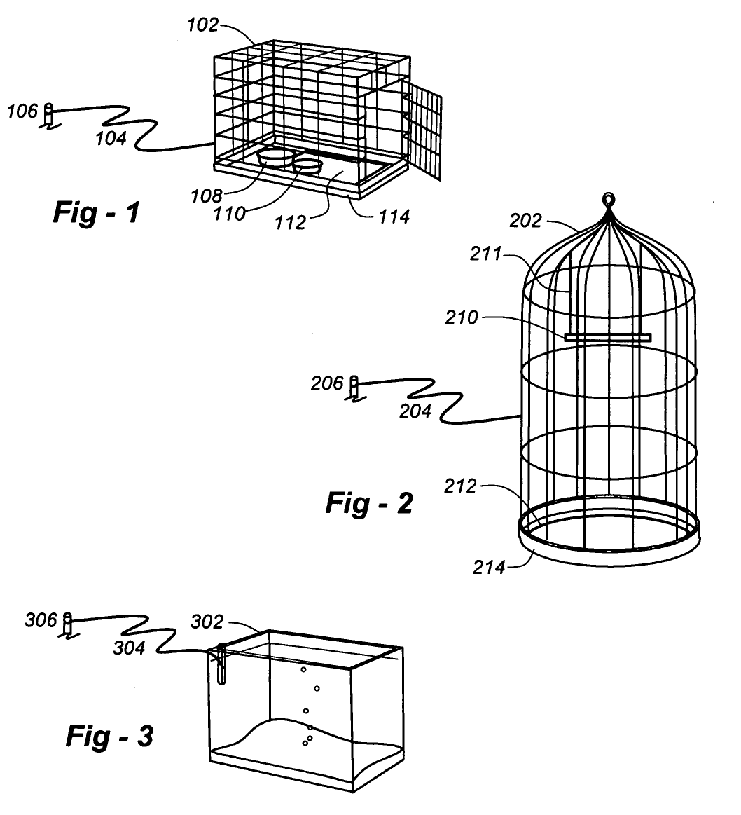

FIG. 1 is a drawing that shows the invention applied to a small animal cage. According to the invention, a ground-rod, preferably a ⅜″ dia. copper rod 106 is driven at least 1 foot into native soil, preferably somewhat moist. Electrically attached to the rod is a wire 104, preferably insulated solid or stranded copper, on the order of 18 AWG or heavier. This wire is run into the home, lab, stable or livestock area through a window or a hole in the wall. The conductor either makes direct (i.e., soldered) connection or terminates in a conductive connector such as an alligator clip which, in the case of FIG. 1, contacts the conductive elements of cage 102. Although a direct, independent, hardwired connection is preferred, in cases of tall buildings, and the like, the grounded prong on an available electrical outlet may alternatively be used.

Other items in the cage 102 are either already or electrically conductive or they are made that way according to the invention, including water bowl 108, food bowl 110, pad 108, or base 114, thereby maximizing potential contact between the caged animal(s) and earth ground. In a cage for a hamster or other small mammal, connection may also be made to the treadmill wheel.

As a cage pad or liner or for indoor uncaged animals, a soft conductive material is placed on the floor of the animal's house or sleeping cushion, and attached to ground via cabling just described. In these applications, an electrically conductive mesh fabric is preferred. Suitable materials may be found at the website http://www.lessemf.com. For example the “high performance silver mesh” from this source is appropriate, since it has very high conductivity (low resistance). Alternatively, however, even high resistance fabrics, say in the 200 kilohm to 1 megohm range, will also work. The “high performance silver mesh” provides maximum shielding performance with surface resistivity is <0.5 Ohm/sq. and a shielding effectiveness is >60 dB from 30 MHz to 3 GHz. It can be used over a wide range of temperatures (−30- to 90-C) to make pads and liners as well as draperies, tents, garments, and more. It has a good tear strength, is very soft and comfortable to touch, with a 0.0045 inch thickness and weighs only 40 grams/m.

FIG. 2 is a drawing that shows the invention applied to a bird cage 202. Again, connection is preferably made to a ground stake 206 through wire 204, making connection to the metal elements of the cage as well as the perch 210 through conductive supports 211. Base 214 and liner pad 212 may also be electrically conductive. FIG. 3 is a drawing that shows the invention applied to an aquarium 302. Connection is made to a ground stake 306 through wire 304, making connection to the metal elements of the aquarium such as the corner ribs. Alternatively, or in addition, the conductor 304 may terminate in an electrically conductive rod immersed in the water or applied to a metal foil strip exposed to the water, on the outer side of the aquarium heater, for example. It is presumed that the water conductivity, particularly salt water, will be sufficient to provide the desired result. The invention is also applicable to larger man-made ponds, such as koi ponds, whether indoors or out.

I claim:

1. Animal electrical grounding apparatus, comprising:
a housing for containing an animal; and
an electrically conductive element having a first end connected to an electrical ground and a second end connected to a portion of the housing or a member within the housing,
whereby the animal is intentionally electrically grounded upon contact with the portion of the housing or member within the housing.

2. The apparatus of claim 1, wherein the housing is an electrically conductive cage.

3. The apparatus of claim 1, wherein the member within the housing is an electrically conductive perch.

4. The apparatus of claim 1, wherein the member within the housing is an electrically conductive food or water bowl.

5. The apparatus of claim 1, wherein the member within the housing is an electrically conductive sleeping pad.

6. The apparatus of claim 1, wherein the member within the housing is an electrically conductive food or water bowl.

7. The apparatus of claim 1, wherein:
the housing is an aquarium; and
the member within the housing is an electrically conductive element disposed within the water of the aquarium.

8. Animal electrical grounding apparatus configured for use with an animal housing having one or more electrically conductive parts, the apparatus comprising:
an electrically conductive element having a first end connected to an electrical ground and a second end connected to at least one of the electrically conductive parts;
whereby the animal is intentionally electrically grounded upon contact with the parts.

9. A method of electrically grounding an animal, comprising the steps of:
providing an animal housing having one or more electrically conductive parts; and
electrically grounding one or more of the parts such that an animal contained in the housing is intentionally electrically grounded upon contact with the parts.

10. The method of claim 9, wherein the step of providing an animal housing having one or more electrically conductive parts includes providing a cage having electrically conductive ribs.

11. The method of claim 9, wherein the step of providing an animal housing having one or more electrically conductive parts includes providing an electrically conductive food or water bowl.

12. The method of claim 9, wherein the step of providing an animal housing having one or more electrically conductive parts includes providing an electrically conductive perch or treadmill wheel.

13. The method of claim 9, wherein the step of providing an animal housing having one or more electrically conductive parts includes providing an electrically conductive liner or sleeping pad.

14. The method of claim 9, wherein the step of electrically grounding one or more of the parts includes the steps of:
driving a stake into the ground; and
connecting a wire between the stake and the housing or an item contained therein.
